(19) United States
(12) Patent Application Publication
(10) Pub. No.: US 2019/0311316 A1
(43) Pub. Date: Oct. 10, 2019

(54) DISTRIBUTION AND INVENTORY SYSTEM AND METHODS OF USING THE SAME

(71) Applicant: Johnson & Johnson Vision Care, Inc., Jacksonville, FL (US)

(72) Inventors: Edward R. Kernick, St. John, FL (US); James M. Scolaro, Ponte Vedra Beach, FL (US); Kyungmin Lee, Fort Lee, NJ (US); Ernesto Nieves, Ponte Vedra Beach, FL (US); Ahmed Tawfik, Jacksonville, FL (US); Kimberly Pierce, Jacksonville, FL (US); Richard N. Capobianco, Rochester, NY (US); James Miller, Victor, NY (US)

(21) Appl. No.: 16/222,819

(22) Filed: Dec. 17, 2018

Related U.S. Application Data
(60) Provisional application No. 62/599,593, filed on Dec. 15, 2017.

(51) Int. Cl. G06Q 10/08; G07F 11/46

(52) U.S. Cl. CPC G06Q 10/087; A45C 11/005; G07F 11/46; G06Q 10/083

(57) ABSTRACT

The present disclosure is directed to a dispensing system including: a product loading unit; a receptacle configured to receive the product loading unit; a storage area configured to receive product; and a transfer unit for moving the product between the product loading unit and the storage area. The present disclosure is also directed to a dispensing system including: a product loading unit; a receptacle configured to receive the product loading unit; a storage area configured to receive product; a transfer unit for moving the product between the product loading unit and the storage area; and a remote system operable to send and/or receive product information from the dispensing system regarding an amount of product and a type of product within the receptacle.

### CROSS REFERENCE TO RELATED APPLICATIONS

This patent application claims priority to U.S. Patent Application Ser. No. 62/599,593, filed Dec. 15, 2017.

### BACKGROUND OF THE DISCLOSURE

The present disclosure relates to dispensing devices for ophthalmic lenses, and more particularly to systems to dispense ophthalmic objects, record and track patient information, determine different lenses for patients, and to track and control inventory of ophthalmic lenses in the offices of eye care professionals.

In a typical office of an eye care professional, or ECP, many different ophthalmic lenses are kept in inventory in order to dispense to a patient that enters the office. Typically, a patient will have his or her eyes examined to determine if corrective lenses are necessary and, if so and if the patient desires contact lenses, for example. In order to dispense such lenses, the ECP will keep many lenses in stock in the office in order to first test whether a specific lens is appropriate and to give the patient a sufficient quantity until a complete order can be sent.

Manual and automated dispensing machines are known and utilized for dispensing a wide variety of items ranging from snacks and hot meals to health-related items such as certain over-the-counter medications. The vast majority of these dispensing machines are vending machines that are utilized as point of sale devices. While dispensing and vending machines are utilized in many areas, they are not widely used in the health care market. In the field of eye care, for example, eye care professionals still dispense trial contact lenses from drawers manually stocked by themselves and sales representatives of the lens manufacturers. These drawers require manual inventory control and simply hold the contact lenses. Further, there is a need to develop a system for stocking the lenses manually. Different stock keeping units, or SKUs, need to be segregated by attributes such as refractive power; wear regimen such as daily, weekly, bi-weekly or monthly wear; lens manufacturer; and lens material. This necessarily requires the use of many drawers that are not completely full in order to keep track of what is in inventory and to more easily locate a lens of choice when a physician selects for a patient.

There exists a need, however, for dispensing machines and systems that may be utilized by eye health care professionals as a tool to assist such professionals with a means and method for providing the patient with real time access to a wide variety of contact lenses in a timely manner. Such machines could also be used to better manage the large number of lenses that need to be kept in stock with automated inventory control. Such machines and systems would also be used by manufacturers of such lenses to provide immediate access to those lenses which fit the needs of each particular, individual patient. In addition, the dispensing system can deliver product information to conduct data analytics to better provide new products that better meet such patients' needs.

Embodiments of the present disclosure provide devices and methods that address the above clinical needs.

### SUMMARY OF THE DISCLOSURE

The present disclosure is directed to systems and dispensing systems.

The present disclosure is directed to a dispensing system including: a product loading unit; a receptacle configured to receive the product loading unit; a storage area configured to receive product; and a transfer unit for moving the product between the product loading unit and the storage area. The present disclosure is also directed to a dispensing system including: a product loading unit; a receptacle configured to receive the product loading unit; a storage area configured to receive product; a transfer unit for moving the product between the product loading unit and the storage area; and a remote system operable to send and/or receive product information from the dispensing system regarding an amount of product and a type of product within the receptacle.

The present disclosure is directed to a system for managing inventory in a dispensing system including: a dispensing system, a computer that is able to track inventory in the dispensing system, patient information, a cloud based server system that is able to collect dispensing information from dispensing systems, a manufacturing system that is able to obtain dispensing information, and an analytic system that is able to predict what the future inventory needs of the dispensing system will be.

### BRIEF DESCRIPTION OF THE DRAWINGS

The present disclosure will be better understood by reference to the following drawings, which are provided as illustrative of certain embodiments of the subject application, and not meant to limit the scope of the present disclosure.

FIG. 1 is an illustration of an overview of one embodiment of the disclosed system.

FIG. 2 is an illustration of an overview of the operation of the disclosed system.

FIG. 3A is an illustration of a front and perspective view of the exterior of a dispenser of the first embodiment.

FIG. 3B is an illustration of a side and rear view of the exterior of the dispenser of the first embodiment.

FIG. 3C is an illustration of a cross sectional view of the dispenser of the first embodiment.

FIG. 3D is an illustration of a cross sectional view and a front view of the dispenser of the first embodiment.

FIG. 3E is an illustration of a magnified view of a plurality of shelves of the dispenser of the first embodiment.

FIG. 3F is an illustration of a perspective view of the frame of the dispenser of the first embodiment.

FIG. 3G is an illustration of a top view and a front view of the carriage of the dispenser of the first embodiment.

FIG. 3H is an illustration of a top view and side view of the picker head of the dispenser of the first embodiment.

FIG. 3I is an illustration of a perspective view of the magazine of the dispenser of the first embodiment.

FIG. 3J is an illustration of the side view and the perspective view of the internal mechanisms of the dispenser of the first embodiment.

FIG. 3K is an illustration of perspective views of the carriage and the picker head of the dispenser of the first embodiment.

FIG. 4A is an illustration of a perspective view of the outside of a dispenser of the second embodiment.

FIG. 4B is an illustration of two perspective views of the internal mechanisms of the dispenser of the second embodiment.

FIG. 4C is an illustration of two perspective views of the carriage of the dispenser of the second embodiment.

FIG. 4D is an illustration of two perspective views of the shuttle of the dispenser of the second embodiment.

FIG. 4E is an illustration of a perspective view and a front view of the carriage belt of the dispenser of the second embodiment.

FIG. 5A is an illustration of a top view of the outside of a dispenser of the third embodiment.

FIG. 5B is an illustration of a top view of the internal mechanisms of the dispenser of the third embodiment.

FIG. 5C is an illustration of a perspective view of the outside of the dispenser of the third embodiment, with the cover removed.

FIG. 5D is an illustration of a perspective view of the outside of the dispenser of the third embodiment, with the covers removed.

### DETAILED DESCRIPTION OF THE DISCLOSURE

In the discussion and claims herein, the term “about” indicates that the value listed may be somewhat altered, as long as the alteration does not result in nonconformance of the process or device. For example, for some elements the term “about” can refer to a variation of ±0.1%, for other elements, the term “about” can refer to a variation of ±1% or ±10%, or any point therein.

As used herein, the term “substantially”, or “substantial”, is equally applicable when used in a negative connotation to refer to the complete or near complete lack of an action, characteristic, property, state, structure, item, or result. For example, a surface that is “substantially” flat would either completely flat, or so nearly flat that the effect would be the same as if it were completely flat.

As used herein terms such as “a”, “an” and “the” are not intended to refer to only a singular entity, but include the general class of which a specific example may be used for illustration.

As used herein, terms defined in the singular are intended to include those terms defined in the plural and vice versa.

References in the specification to “one embodiment”, “certain embodiments”, some embodiments” or “an embodiment”, indicate that the embodiment(s) described may include a particular feature or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. For purposes of the description hereinafter, the terms “upper”, “lower”, “right”, “left”, “vertical”, “horizontal”, “top”, “bottom”, and derivatives thereof shall relate to the invention, as it is oriented in the drawing figures. The terms “overlying”, “atop”, “positioned on” or “positioned atop” means that a first element, is present on a second element, wherein intervening elements interface between the first element and the second element. The term “direct contact” or “attached to” means that a first element, and a second element, are connected without any intermediary element at the interface of the two elements.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc.

The present disclosure is directed to dispensing systems, and systems for controlling the inventory, shipment and distribution of various elements, such as contact lenses. The system is discussed below, followed by a discussion of the various dispensing systems that can be used with the system. How various users interact with the various systems is discussed below.

A patient enters an office, such as an optometry office, and is interested in receiving contact lenses. Information about the patient is gathered, such as in a lifestyle form where the patient can provide details of their work routine, can be stored in a remote/cloud database 300 for further use. This database 300 can be any suitably available cloud based service configured to interact, receive and transmit data among many devices in differing locations.

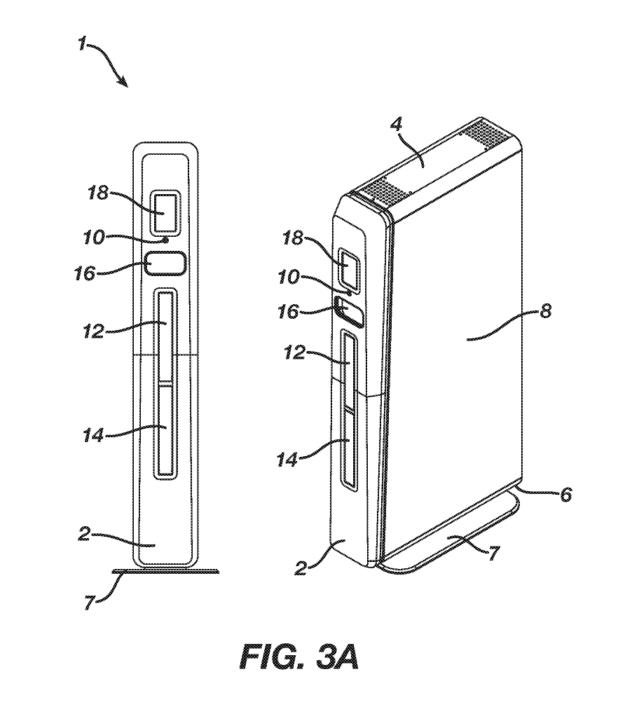

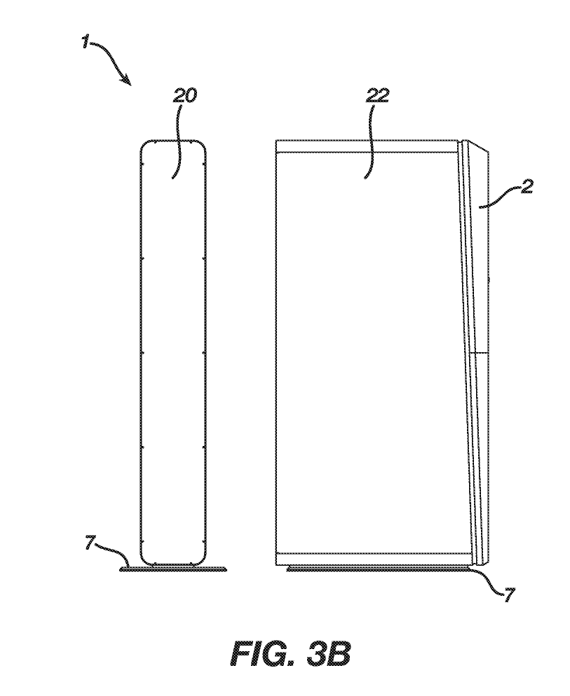

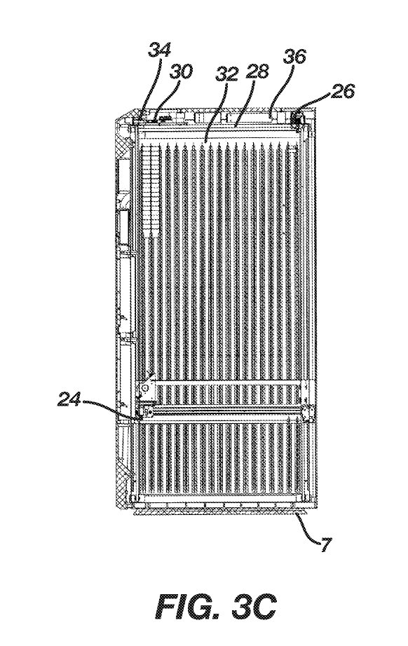

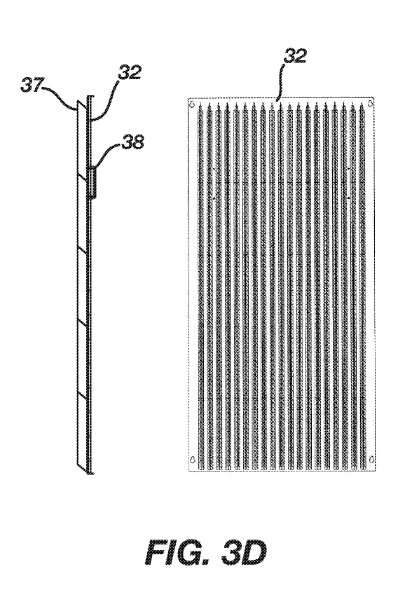

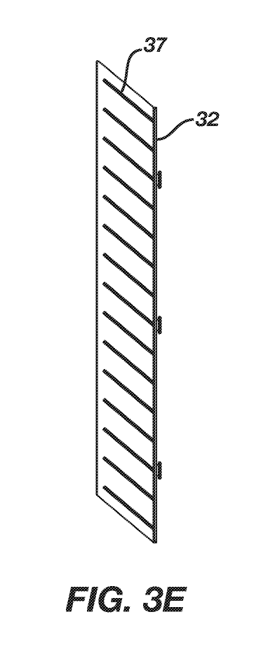

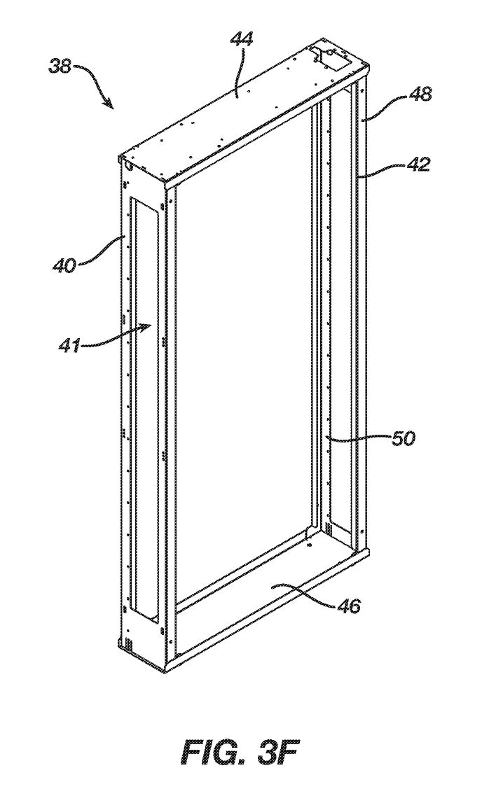

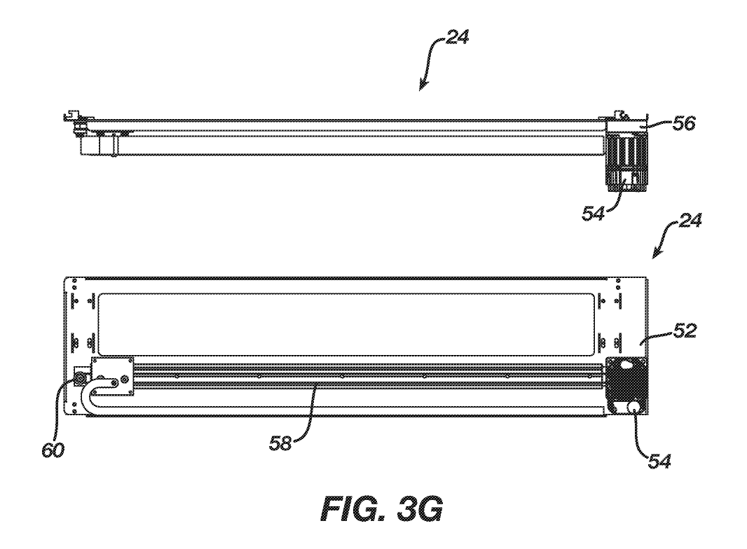

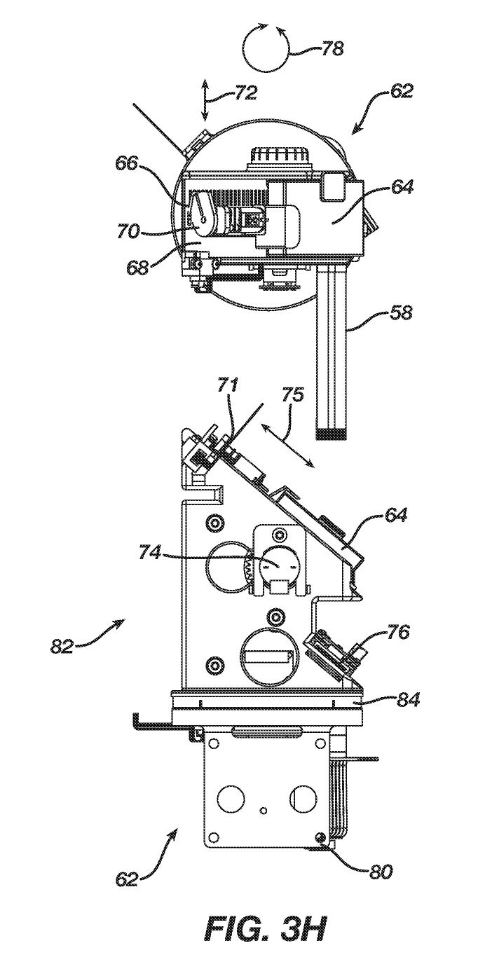

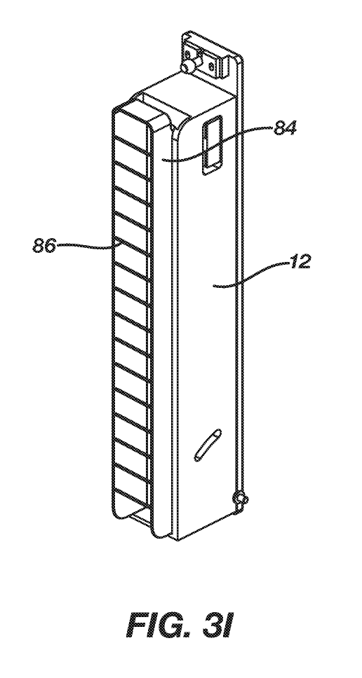

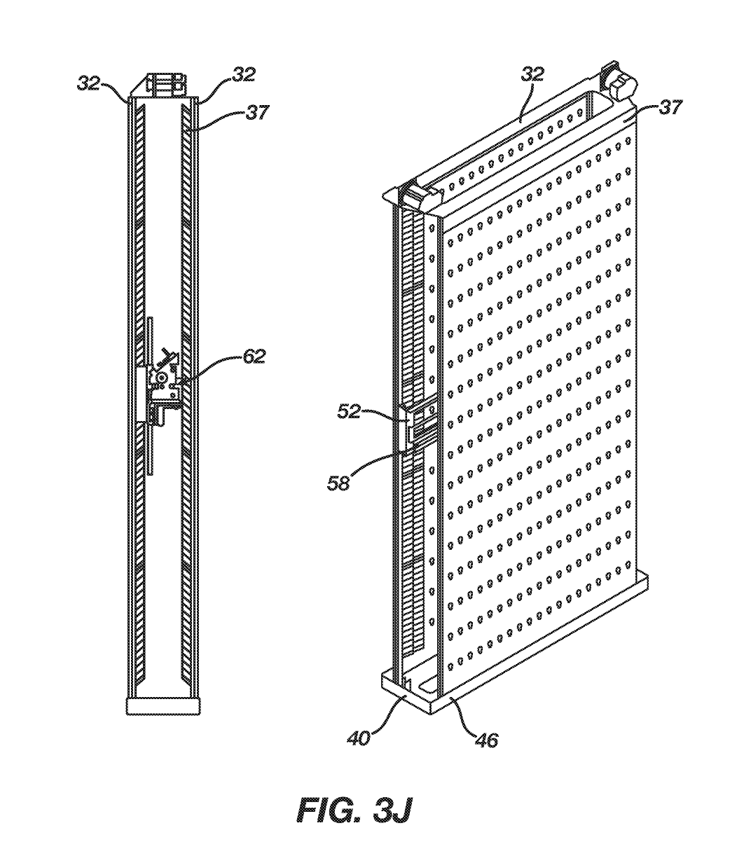

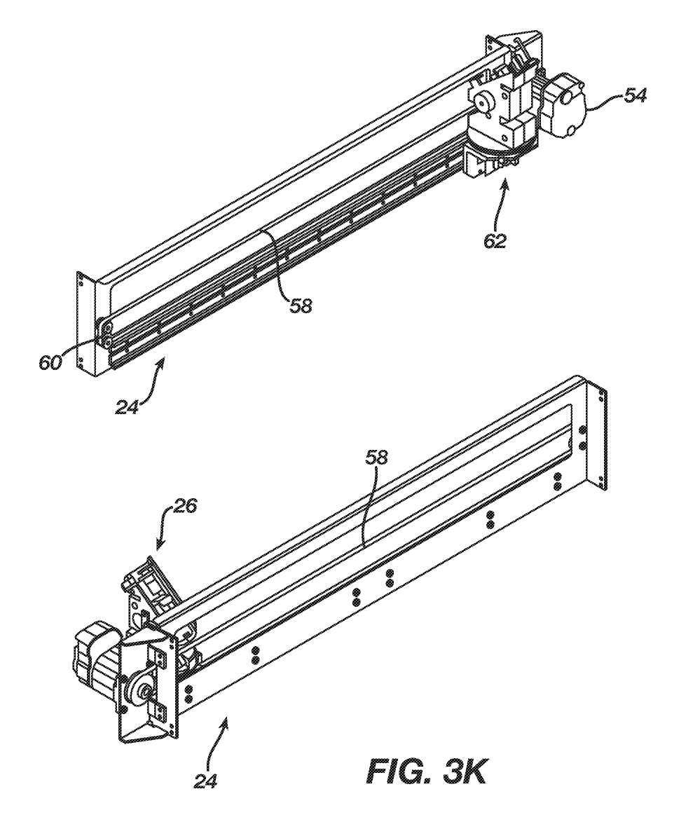

The patient can undergo pre-testing, the results of which can be gathered and can be transmitted to the remote/cloud database 300. All gathered information can be used by the remote/cloud database 300 to suggest one or more kinds of contact lenses that may be suitable for the patient, and can also be used by the remote/cloud database 300 to check on the inventory of those contact lens in one or more dispensing systems 302 located in the office. This dispensing system 302 will be more fully discussed below with reference to FIGS. 3A-5D, with any of the embodiments discussed therein being suitable for the dispensing system 302.

The operator of the dispensing system, which can be an optometrist or a technician, can also have access to all previously gathered information, and can request that the dispensing system dispense a specific contact lens after the initial information is gathered, or after a full eye exam is completed. After a specific contact lens is determined, the operator's decision can be sent to the remote/cloud database 300, which can then reply with data regarding best practices of using that contact lens. For example, the remote/cloud database 300 can automatically ship a contact lens welcome kit to the patient's home, through contacting a carrier service and effecting shipment orders. The remote/cloud database 300 can also provide a notification (such as an email or text message) to the patient and/or operator that the contact lens welcome kit has shipped.

The dispensing system 302 can also receive information to dispense a certain amount of contact lenses from the dispensing system's inventory.

The remote/cloud database 300 is configured to maintain records regarding all distributed contact lenses from the dispensing systems so that an inventory can be maintained for each dispensing system.

The remote/cloud database 300 can be used to manage inventory at a number of dispensing systems distributed across multiple geographical areas and multiple commercial locations (e.g. Costco®, LensCrafters®, etc.). The remote/cloud database 300 can automatically ship more supplies of contact lenses to each location, to replenish inventory that has been distributed, and the remote/cloud database 300 can anticipate the need for more supply at a location and automatically ship more supplies of contact lenses to that location. Over time, the remote/cloud database 300 can optimize the anticipatory shipments based on past behaviors of specific locations, and past behaviors of locations similar to the specific location.

Alternatively, instead of automatically shipping more contact lens supplies to the location, the remote/cloud database 300 can provide a notification (such as an email or text message) to the operator at the location that inventory is below a threshold. The operator could then request the shipment of a suggested amount of contact lens inventory, or modify the amount to a desired amount of contact lens inventory to be shipped to their location.

Upon receipt of additional contact lens inventory, the operator at the location can add the received inventory to the dispensing system 302. The dispensing system can include a reader (such as a bar code reader, a QR code reader, a Radio Frequency Identification (RFID) reader, etc.) to read and record the received contact lens shipment as it is added to the dispensing system's 302 inventory. The updated inventory of the dispensing system 302 and the shipping records stored in the remote/cloud database 300 can be compared by the remote/cloud database 300 to determine if all shipped contact lenses were added to the dispensing system's 302 inventory.

Once the received contact lenses are added to the dispensing system's 302 inventory, their expiration date can be recorded and tracked, so a warning can be provided by the dispensing system that a certain contact lens is expired and not to be given to a patient. Also, the remote/cloud database 300 can send a notification to the dispensing system 302 that a certain contact lens is the subject of a recall, so a warning can be provided by the dispensing system 302 that a certain contact lens is subject to a recall and not to be given to a patient. In other embodiments, an operator of the dispensing system 302 can manually remove certain contact lenses from the dispensing system 302.

Each kind of dispensing system 302 is configured to interface and/or connect wirelessly or a wired connection with an input device operated by an operator in an office, and with the remote/cloud database 300.

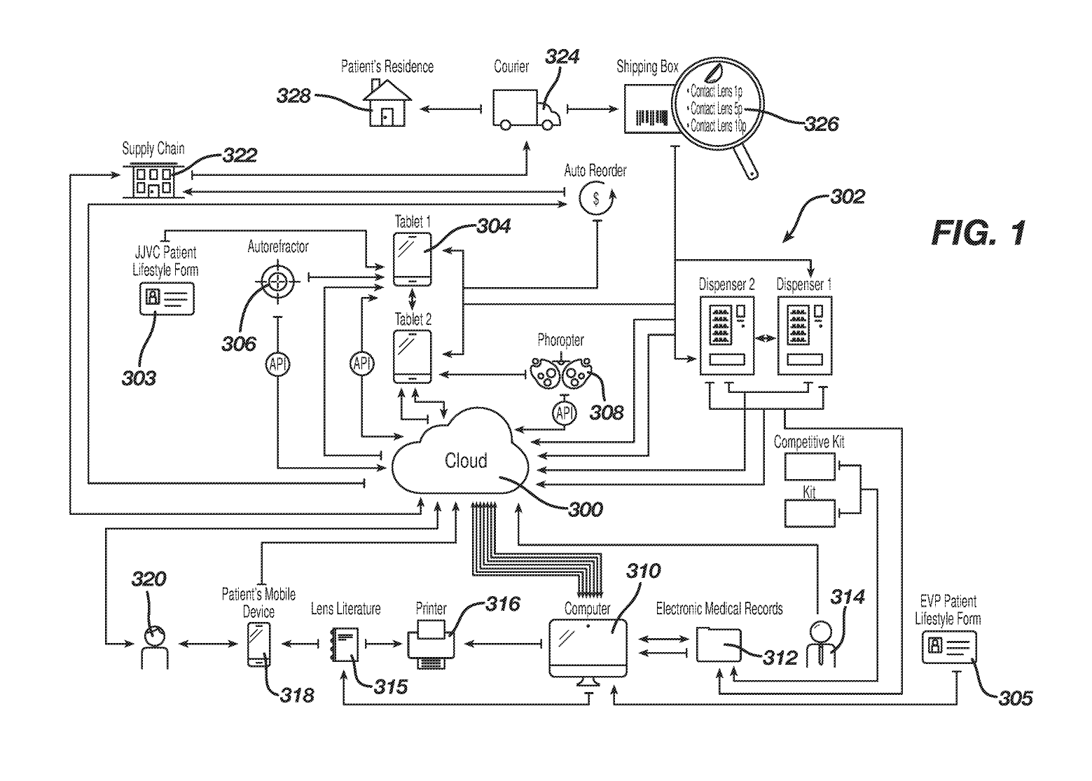

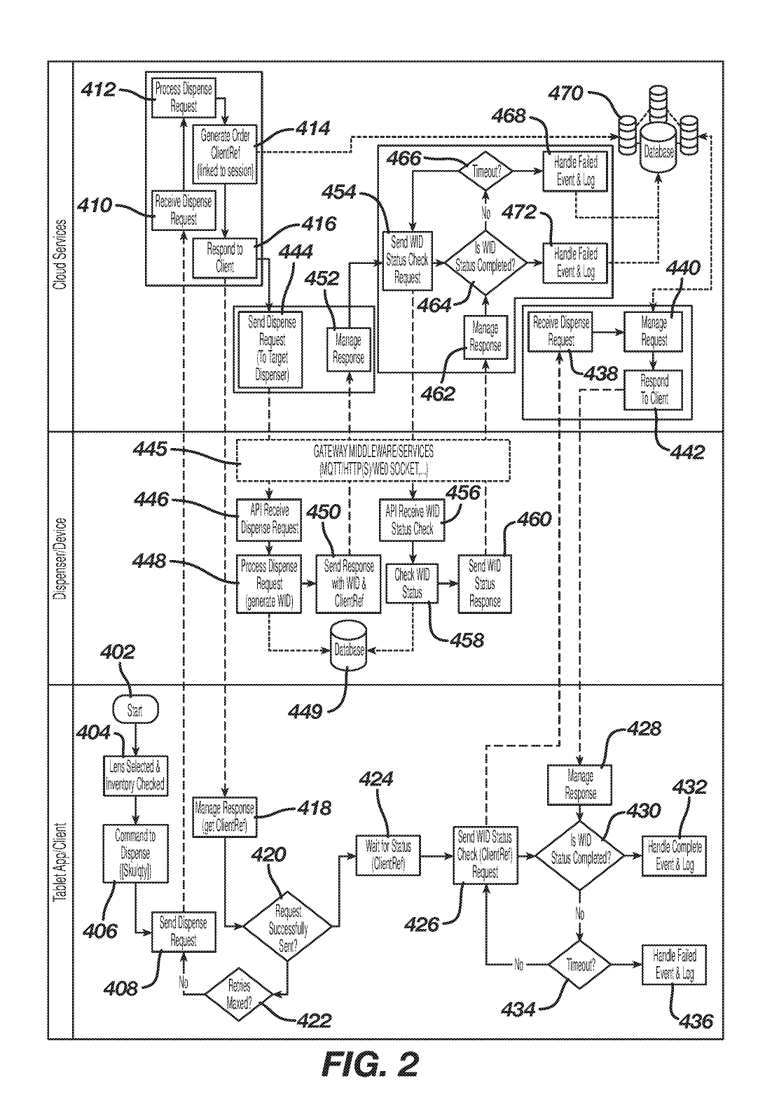

An overview of one embodiment of the system is shown in FIG. 1. A discussion of the system illustrated in FIG. 1 follows, with a discussion of FIG. 2 supplementing this discussion. In FIG. 1, the “Cloud” element (remote/cloud database 300) receives and outputs from several different elements throughout the figure.

All of the lines connecting each element represent lines of transmission, either wirelessly or through a wired connection, between each element. The elements transmit and receive data with one another in any suitable way, such as through application programmed interfaces “API” that are specifically configured for data transmission between two specific elements.

To the left of the remote/cloud database 300 a Lifestyle Form 303, completed by a patient on, for example Tablet 304, is transmitted to the remote/cloud database 300, as well as data regarding the patient's Autorefractor 306 measurements, and the patient's Phoropter 308 measurements. The Tablet 304, Phoropter 308 and Autorefractor 306 are typically all within an operator's office space.

To the bottom of the remote/cloud database 300 the computer 310, which is present at the operator's office space interacts with the remote/cloud database 300, receiving data regarding the patient's lifestyle form 303/lifestyle form 305 and the patient's Autorefractor 306 measurements, and the patient's Phoropter 308 measurements. These data can be stored in the patient's Electronic Medical Records 312 and be reviewed by the operator 314 (Eyecare Professional). The Electronic Medical Records 312 can also store data regarding previous kits of contact lenses from one or more manufacturers, which have been suggested or prescribed by the operator to the patient in the past.

The computer 310 can also provide specific contact lens literature 315 to the patient by having the information printed through a printer 316, or transmitted to the patient's mobile device 318. The computer 310 can also make information available to the patient through the patient's user Account 320.

Based on past data, lifestyle data and all data gathered at the operator's office space, a specific contact lens choice can be transmitted to one or both of Dispenser 1 and Dispenser 2 of dispensing system 302. This dispensing system 302 is configured to dispense the requested contact lens, in a suitable package, to the operator. The dispensing and inventory of the contact lens within each of Dispenser 1 and Dispenser 2 of dispensing system 302 can be stored in the remote/cloud database 300.

This inventory data can be updated routinely or on a specific schedule based on restocking of the dispensing system 302, or removal from the dispensing system 302 of certain contact lenses.

Inventory can be tracked by the dispensing system 302 through a scanning procedure for each dispenser, of scanning and recoding each contact lens added to the dispenser and each contact lens dispensed therefrom. This recording of each contact lens added and each contact lens dispensed can be stored and reviewed by the remote/cloud database 300, which can automatically, or through a person's specific intervention, request shipment of further contact lens inventory 326 from a Supply Chain 322, through a courier 324 to the operator's office space. These newly shipped contact lenses can be added to the dispensing system 302 as needed or desired. Also, each box used to store the contact lenses can be scanned (such as by a bar code on the exterior of the box) upon adding them to the dispensing system 302, so the dispensing system 302 can record and store their current inventory levels.

Rather than having the dispensing system 302 provide contact lenses for the patient in the future, the operator of Tablet 304 can request an automatic reorder of the contact lenses be sent from the Supply Chain 322, through a Courier 324 to the Patient's residence 328.

A more detailed flow diagram of the system is shown in FIG. 2. A method utilized with this system begins in the lower box at “Start” 402. This lower box incorporates an application stored and run on a Tablet 304 (or other suitable electronic device) in an operator's office. The middle box includes data and instructions received and carried out by the dispensers in the operator's office. The top box includes data and instructions received by and transmitted from the remote/cloud server.

Upon the beginning of the operation, a specific contact lens has been selected by the operator in step 404, and the inventory with each dispense in the operator's office space is checked. A command to dispense 406 the specific contact lens (which is contained with a suitable package), this command containing identifying information of the specific contact lens (e.g. a stock keeping unit (SKU)) and a quantity to be dispensed is transmitted/sent from the application in step 408 to the remote/cloud database 300. The remote/cloud database 300 receives this dispense request in step 410, processes the request in step 412, generates an order in step 414 and responds with that order in step 416 to the operator.

The generated order also is transmitted to a server, which stores such order for future reference.

Referring again to the response sent to the operator, the response to the operator (through the tablet in the operator's office space) is managed and assigned a Client reference in step 418. The tablet can ask if the request was successfully sent to the dispenser in step 420, and if not, can retry until a maximum threshold number of retries is reached in step 422, at which point the method ends.

If the request was successfully sent to the dispenser the tablet waits for any status updates in step 424 regarding the Client reference from the remote/cloud database 300 and then sends a WID status check request in step 426 to the remote/cloud database 300, which receives this request in step 438. The cloud manages this request in step 440 by communicating back and forth with the server about whether or not the request has been sent to/been received by the dispensing system 302 in step and responds back to the tablet regarding the status in step 442.

The tablet manages the response in step 428 and if the status is that dispensing is completed in step 432, the method ends and the result is stored. If the status is that dispensing is not complete, and the amount of time between the request being sent is beyond a timeout threshold in step 434, the method is completed and the result is stored in step 436. If the status is that dispensing is not complete, and the amount of time between the request being sent is less than a timeout threshold, the tablet again sends a WID status check request of step 426 to the remote/cloud database 300.

Along with responding to the operator's tablet based on the Dispense request of step 408 received by the remote/cloud database 300, the remote/cloud database 300 sends a dispense request to the dispensing system 302 in step 444. All transmissions from the remote/cloud database 300 to the dispensing system 302 and from the dispensing system 302 to the remote/cloud database 300 passes through a suitable middleware service 445 that provides suitable communication between the two elements.

The application programmed interface “API” of the dispenser receives the dispense request in step 446 from the cloud and processes the dispense request in step 448, thereby generating a WID. This WID is maintained throughout the method and is maintained for a specific dispensing request between the dispensing system 302, the remote/cloud database 300 and the operator's tablet. This processing of the request, and generation of the WID, is stored within a database 449 of the dispensing system 302.

After processing the request, the response, along with the WID and Client reference, are sent to the remote/cloud database 300 in step 450, which manages the response in step 452 and subsequently sends a WID status check request back to the dispensing system 302 in step 454. The API of the dispensing system 302 receives this status check in step 456, checks on the WID status of dispensing in step 458 and sends a response back to the remote/cloud database 300 in step 460, which manages the response in step 462. The checking of the WID status is also stored within a database of the dispenser.

The response sent back to the cloud is managed and it is determined whether the WID dispensing status is completed in step 464. If the status is that dispensing is not complete, and the amount of time between the request being sent is beyond a timeout threshold in step 466, the method is completed in step 468, and the result is stored in database 470. If the status is that dispensing is not complete in step 464, and the amount of time between the request being sent is less than a timeout threshold in step 466, the cloud again sends a WID status check request in step 454 to the dispensing system 302, which again sends a WID status response in step 460 to the remote/cloud database 300. If the status is that the WID dispensing status is that yes the dispensing is complete in step 464, the method is completed in step 472 and the result is stored.

Details regarding the dispensers of the dispensing system 302 discussed above are now provided.

All measurements and/or dimensions shown in the following figures are for exemplary purposes only. In other embodiments, each of these measurements and/or dimensions can be altered in any suitable way. Further, each component can be formed of any suitable material, such as plastic including materials, metal including materials, carbon including materials, rubber including materials, glass including materials, etc. and combinations thereof.

FIG. 3A illustrates a front view and a perspective view of a gantry dispensing system 1. The gantry dispensing system 1 includes several components visible externally, including a front cover 2, a top cover 4, a bottom cover 6, a left side panel cover (not visible in this configuration), a base 7, a right side panel cover 8, a switch 10 to energize the gantry dispensing system 1, an upper magazine cover 12, a lower magazine cover 14, a delivery port (or opening) 16 configured to accept boxes from outside of the gantry dispensing system 1, and a display 18 (which can be any suitable liquid crystal display (LCD) or light emitting diode (LED) display). The interior volume of the dispensing system 1 comprises a storage area configured to receive products and packages.

FIG. 3B illustrates a rear view and left side view of the gantry dispensing system 1. Specifically, a back panel 20 and a left side panel cover 22 are of the gantry dispensing system 1 are shown.

All covers of FIGS. 3A and 3B are configured to contact each other to maintain their respective positions and/or contact an internal frame to maintain their respective positions through any suitable connection elements.

FIG. 3C is a cross-sectional view along line A of FIG. 3A. FIG. 3C illustrates a carriage 24, an upper drive mount 26, a drive shaft assembly 28, a frame assembly 30, a side panel assembly 32, a vertical timing belt 34 (or any suitable drive chain or wire(s)) being connected to the carriage 24 and being configured to move the carriage 24 vertically within the gantry dispensing system 1 through rotation of the drive shaft assembly 28, causing the movement of the vertical timing belt 34. Also shown are electronic elements 36, which can include any suitable electronic control boards, processors, computing elements (such as memory, processors, etc.), wiring, etc.

A more detailed view of the side panel assembly 32 is shown in FIG. 3D. The right portion of FIG. 3D is a front view of the side panel assembly 32, the left portion of FIG. 3D is a cross sectional view along line A of the side panel assembly 32 of the right portion of FIG. 3D.

As can be seen in FIG. 3D, the side panel assembly 32 includes a plurality of shelves 37 that are configured to maintain a plurality of elements, such as any suitable packages, containers, and/or boxes (shown in more detail below), with any suitable contents within the packages, containers and/or boxes. One example of a suitable content is a contact lens package, but this example is just one of many medical or consumer elements that can be maintained on the plurality of shelves 37.

The side panel assembly 32 can also include a handle 38 that aids in installation and/or movement of the side panel assembly.

FIG. 3E is a magnified view of the cross sectional view of FIG. 3D. Specifically, FIG. 3E illustrates a magnified view of the plurality of shelves 37, as they are connected at an angle to side panel assembly 32. The angle between each of the plurality of shelves 37 and the side panel assembly 32 can be any suitable angle so that a box (not shown) can be held against the side panel assembly 32 by gravity, without falling from the plurality of shelves 37. Although not shown, the space between each of the plurality of shelves 37 is configured to accept, maintain, and allow for dispensing of a box.

FIG. 3F is an illustration of a frame 38, that is configured to have the above discussed elements attached thereto. The frame 38 includes a front frame 40, a rear frame 42, a top frame 44 and a bottom frame 46. All pieces of the frame 38 are attached to each other in any suitable way that can maintain their orientation once the elements, such as the front cover 2, the top cover 4, the bottom cover 6, the left side panel cover 22, the rear cover 20, the base 7, the right side panel cover 8, the side panel assembly 32 to an exterior frame surface 48. Various elements can also be attached to the frame 38 by connection to an interior frame surface 50.

The front frame 40 includes a suitable opening 41, which is configured to allow for access to the interior of the gantry dispensing system 1 through the upper magazine cover 12, the lower magazine cover 14, and the delivery port 16, amongst other elements. Other pieces of the frame 38 can also include one or more suitable openings.

FIG. 3G is a view of the carriage 24, as a top view (upper portion of FIG. 3G) and a front view (bottom portion of FIG. 3G). Carriage 24 includes a mount 52, which can mount the carriage 24 to the interior frame surface 50, a carriage motor 54 that is mounted to the carriage 24 through carriage motor mount 56. The carriage motor 54 is configured to cause a looped cable 58 to move about a cable bearing 60. Further views of the carriage 24 are shown below.

Although not shown in FIG. 3G, a picker head (transfer unit) 62, as shown in FIG. 3H can be attached to the cable 58. In FIG. 3H, the upper figure is a top view of picker head 62, while the lower figure is a left side vice of picker head 62.

In FIG. 3H the picker head 62 includes several components that are generally designed to both move a box 64 from a magazine (discussed below) to the shelf 37 and from the shelf 37 (not shown in this figure) to the delivery port 16 (not shown in this figure).

To aid in movement of the box 64, the picker head 62 includes a picking finger 66, a box finger 68, and an actuator 70, with the actuator 70 and box finger 68 being rotatable by an actuator motor 71 in the direction of arrow 72. The picking finger 66, the box finger 68, and the actuator 70 are moved in the direction of arrow 75 by a head motor 74. The angle of arrow 75 is configured to be similar to the angle of the plurality of shelves 37 (shown above in FIG. 3E), and also to be similar to the angle of magazine shelves, discussed below.

To remove the box 64 from the shelf 37, the picker head 62 is moved to the location of the box 64. Optionally, the picker head 62 can include a reader, that can read a code (such as a bar code) or receive a signal (such as a radio frequency identification signal), from the box 64 so the suitable electronic elements 36 can ensure that the box 64 is the desired box. Then, the box finger 68 extends under the lower surface of the box 64, through movement of the head motor 74, until it reaches a rear edge of the box 64, furthest from the picker head 62. Then, the box finger 68 is rotated, through movement of the actuator motor 71, so that a distal end of the box finger 68 contacts a rear surface of the box 64. The box finger 68 is then retracted, through movement of the head motor 74, towards the picker head 62, causing the box 64 to move from the shelf 37 onto the picker head 62.

The picker head 62 is connected to the cable 58 through a flexible connector 76. The picker head 62 is also configured to rotate 360°, the direction of arrow 78 by rotation of head motor 80. Head motor 80 is attached to the picker head 62, and is attached to a picker upper portion 82 through rotation about rotatable connection 84.

In FIG. 3I, upper magazine cover 12 (although lower magazine cover 14 is substantially the same) is shown. The magazine cover 12 holds a magazine 84 (product loading unit), which having a plurality of magazine shelves 86, is configured to load packages (such as box 64) into the gantry dispensing system 1. To effect this loading, a person removes magazine cover 12 from the gantry dispensing system 1, and places one or more packages on one or more of the plurality of magazine shelves 86. The user then places the magazine cover 12 (and consequently the magazine 84) in the corresponding opening of the front panel 2.

FIG. 3J illustrates two views of a majority of the structure within gantry dispensing system 1 (illustrated in FIG. 3A) without the external covers. The right side figure of FIG. 3J is a perspective view of two side panel assemblys 32, the left side figure of FIG. 3J is a front view of two side panel assemblys 32, from a view of the front cover 2 (not shown). In FIG. 3J, several elements of frame 38 are removed for illustrative purposes.

In FIG. 3J, the vertical timing belt is not shown, but would act to move the mount 52 vertically upwards and down between the two side panel assemblys 32, so that the picker head 62 can access each of the vertical rows of the plurality of shelves 37. Carriage motor 54 (not shown) acts to move the picker head 62 horizontally left and right so that each of the horizontal columns of the plurality of shelves 37 can be accessed.

Since picker head 62 is configured to rotate 360°, picker head 62 can rotate approximately 180° from what is shown in the left side figure of FIG. 3J, through activation of head motor 80, so picker head 62 can access the right hand side panel assembly 32. Further, the picker head 62 can rotate approximately 90° towards front frame 40 so that the picker head can remove packages from the magazine 84, or to dispense packages from the plurality of shelves 37 through the delivery port 16 (not shown). Although not shown, in the right side figure of FIG. 3J, the magazine would be near mount 52 once it was loaded into the gantry dispensing system 1.

FIG. 3K illustrates two views of the picker head 62 as it would be mounted to the carriage 24 (which is how it would look in FIG. 3J if the side panel assemblys 32 were removed.

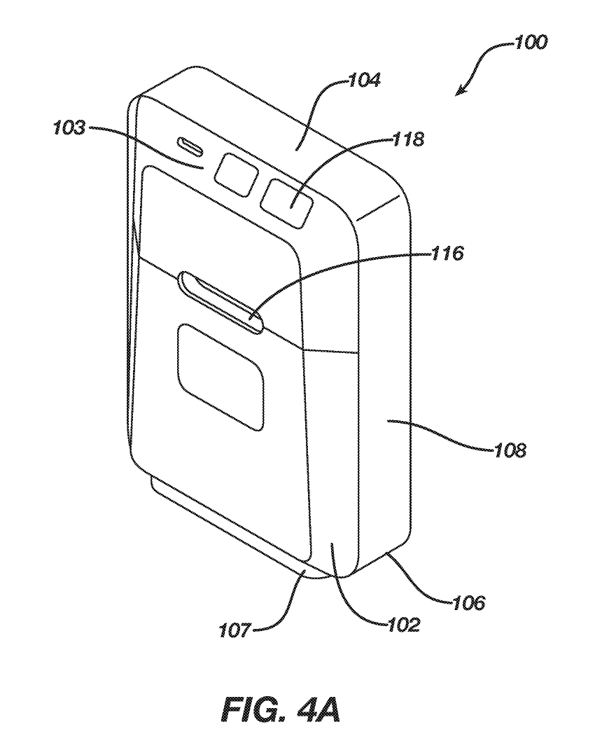

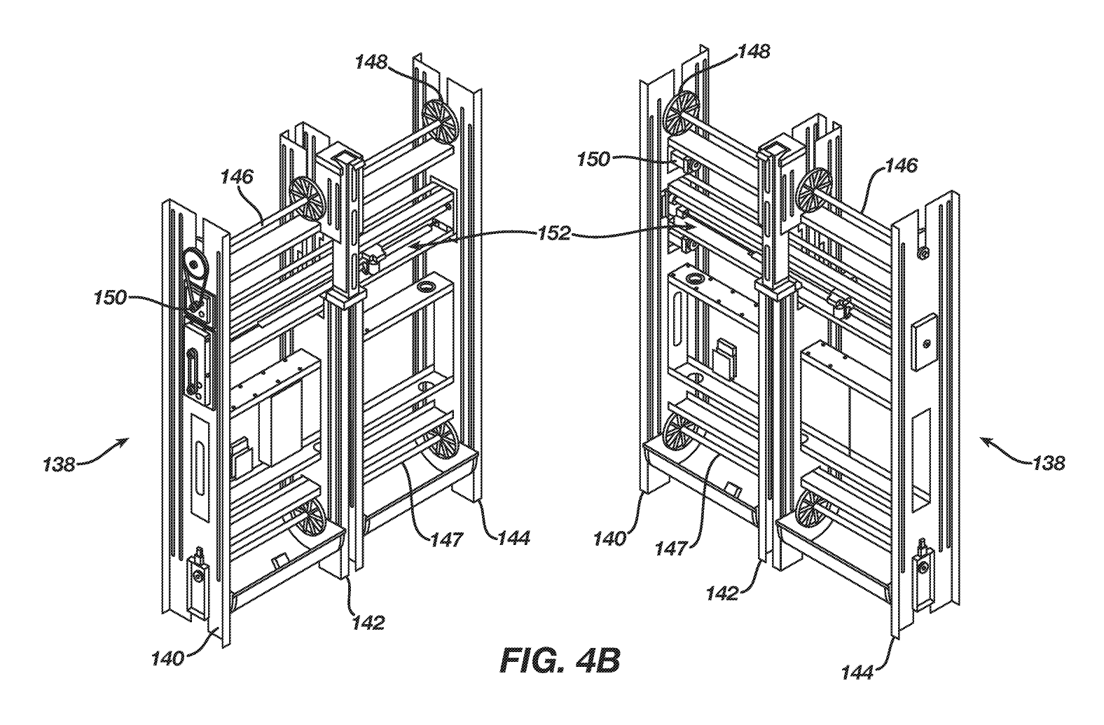

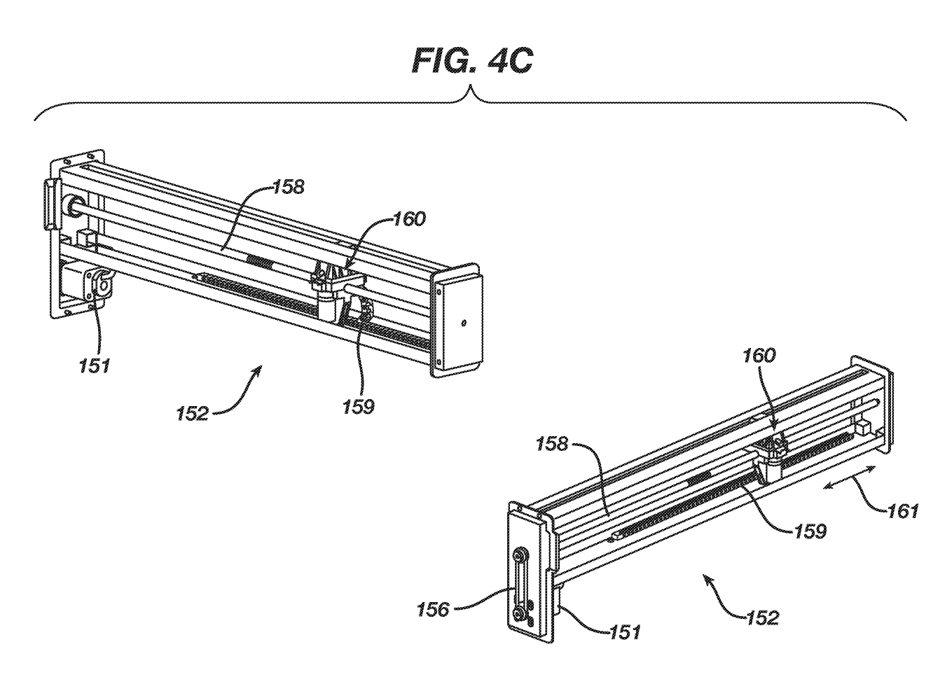

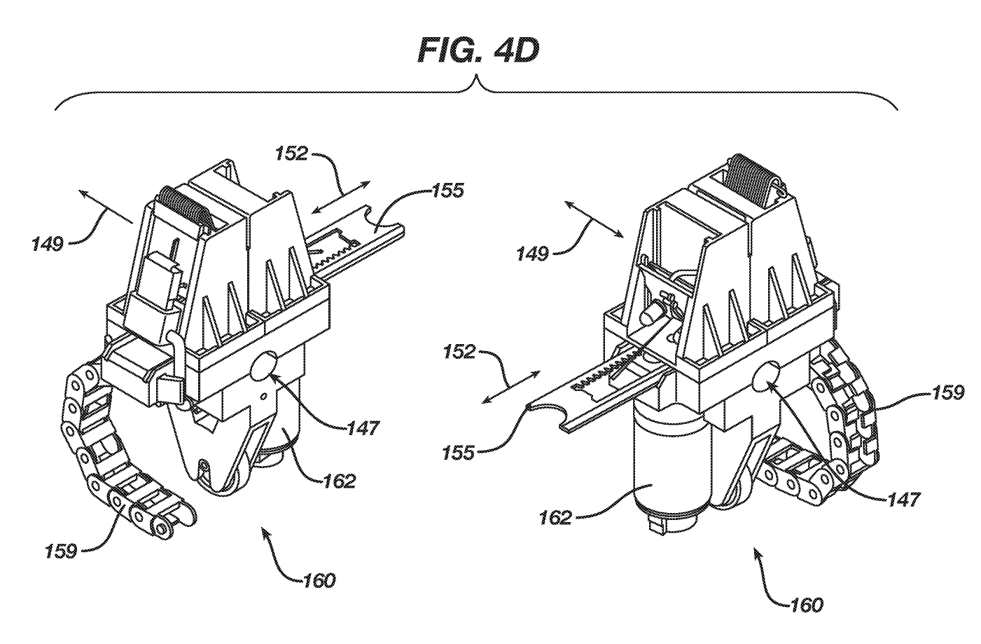

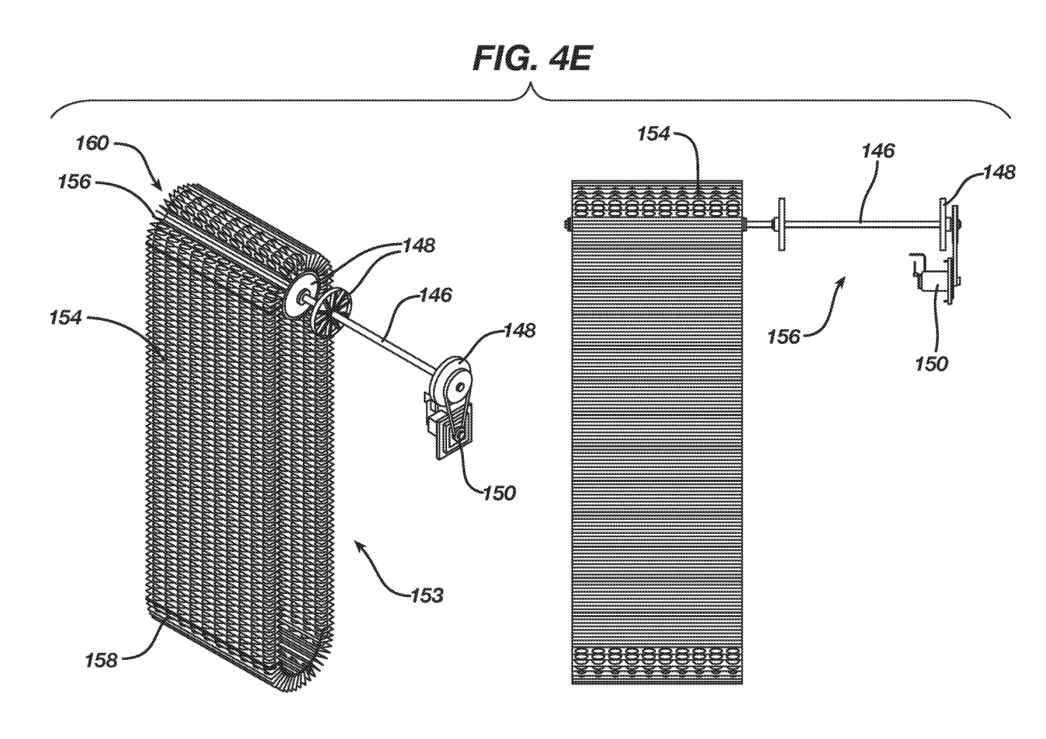

FIG. 4A illustrates a perspective view of another embodiment of a dispenser, a cassette dispensing system 100.

The cassette dispensing system 100 includes several components visible externally, including a lower front cover 2, an upper front cover 103, a top cover 104, a bottom cover 106, a left side panel cover (not visible in this configuration), a base 107, a right side panel cover 108, a delivery port (or opening/product loading unit when combined with the carriage discussed below) 116 configured to accept boxes from outside of the cassette dispensing system 100, and a display 118 (which can be any suitable liquid crystal display (LCD) or light emitting diode (LED) display). The interior volume of the dispensing system 100 comprises a storage area configured to receive products and packages.

The interior of cassette dispensing system 100 (with the above mentioned covers removed) is seen in FIG. 4B. The left image and the right image in FIG. 4B offer differing perspective views of the interior.

A frame 138 includes several components, including a left frame 140, middle frame 142 and a right frame 144 all operably connected to each other. Between the left frame 140 and the right frame 144, an upper axle 146 extends, similarly, between the left frame 140 and the right frame 144, a lower axle 147 extends. Each axle includes four gears 148, with each gear 148 operably attached to the upper axle 146 or the lower axle 147.

A motor 150, attached to the left frame 140 is operably coupled with the upper axle 146 and can cause the upper axle 146 to rotate in the clockwise or counter-clockwise direction. Also included in the frame 138 is a carriage (transfer unit) 152, which is shown in more detail below. The carriage 152 is affixed to left frame 140 and right frame 144, and extends through an opening of the middle frame 142.

FIG. 4C is an illustration of the carriage 152, removed from the frame 138, with two perspective views. The carriage 152 includes a carriage motor 151, which is coupled, through a belt 156 to a shuttle axle 158. Carriage motor 151 is configured to rotate the belt 156 clockwise or counter-clockwise, which subsequently rotates shuttle axle 158 clockwise or counter-clockwise. The rotation of shuttle axle 158 causes a shuttle 160 to move in the direction of arrow 161. More details of the shuttle 160 are discussed below. An electronics belt 159 is configured to house various electrical wires and/or cords (not shown) to deliver electricity to shuttle 160 at each horizontal location along the shuttle axle 158.

FIG. 4D illustrates a more detailed view of shuttle 160, with each figure offering a different perspective view. The shuttle axle 158 is not shown, but would extend through shuttle axle opening 147, causing shuttle 160 to more in the direction of arrow 149. A shuttle motor 162 is coupled with the shuttle 160, and upon rotation, causes ejector 155 to more in the direction of arrow 152.

The entire carriage 152 is designed to fit within a space 153 created between portions of a carriage belt 154, shown in FIG. 4E. A single, circular carriage belt 154 is shown, but in practice, a carriage belt 154 can also be placed in the space nearer the motor 150. The carriage belt 154 is comprised of a number of horizontal strips of material 156, operably attached to a number of vertical strips of material 158, which form a plurality of package openings 160. Although not shown, the right figure of FIG. 48, the portion of the carriage belt 154 that is visible would be oriented towards the front cover of cassette dispensing system 100.

During practice of cassette dispensing system 100, once a suitable package is chosen by a user, motor 150 rotates the appropriate amount so that the suitable package is at a predetermined vertical position on the carriage belt 154. The predetermined vertical position is one that corresponds to the vertical position of the ejector 155.

Once the suitable package is at the predetermined vertical position, the carriage motor 151 rotates, causing the shuttle 160 to move horizontally within the space 153 to the horizontal location of the suitable package. Once at the correct horizontal position, shuttle motor 162 rotates, causes the ejector 155 to extend along arrow 152, contact the package, and force the package from being contained within the carriage belt 154. Once the package is forced from the carriage belt 154, it can fall and be accessed by a user through the delivery port 116.

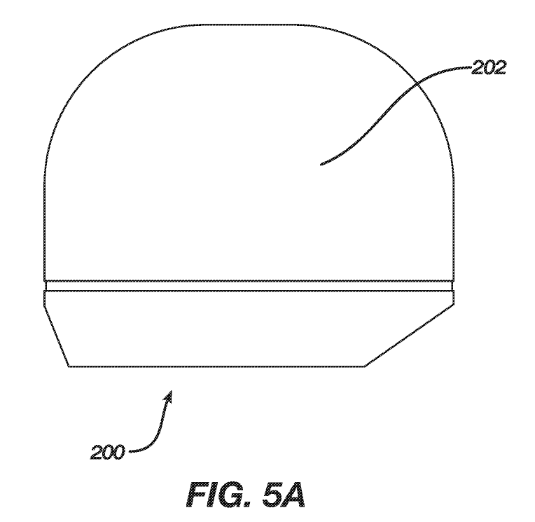

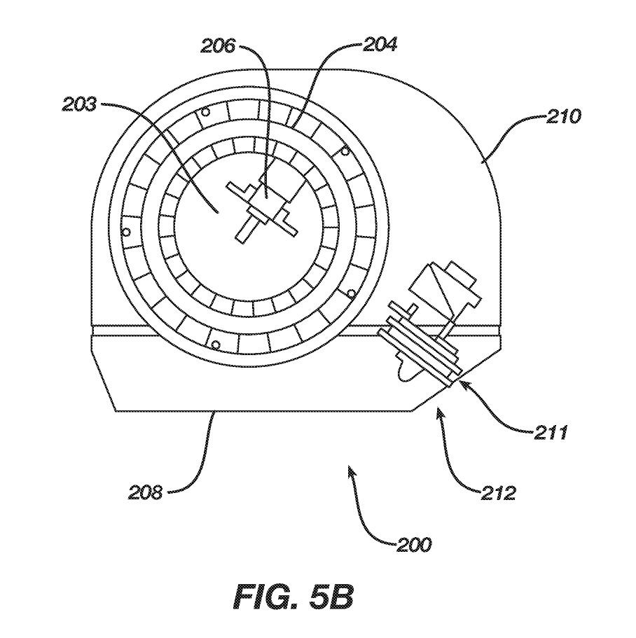

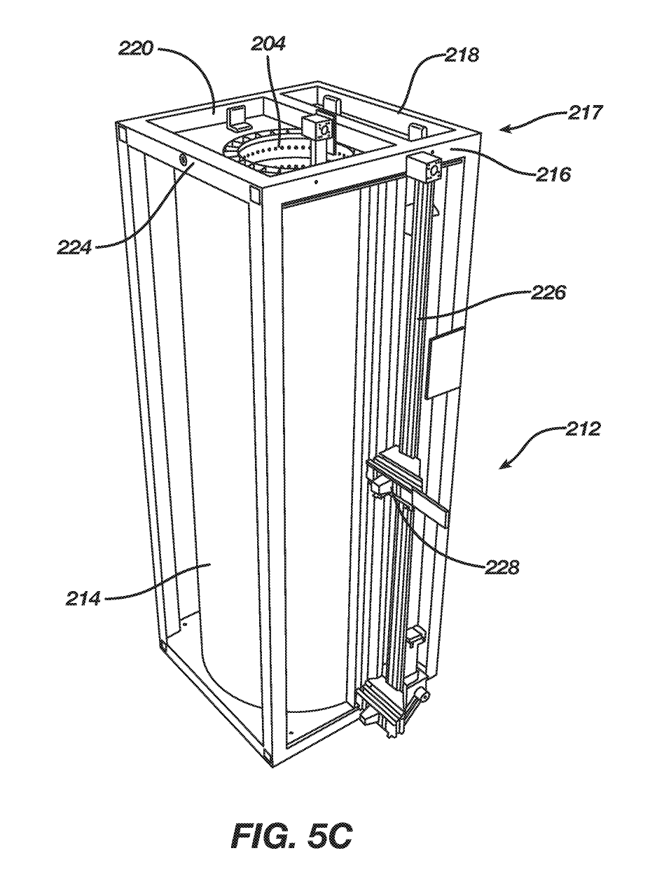

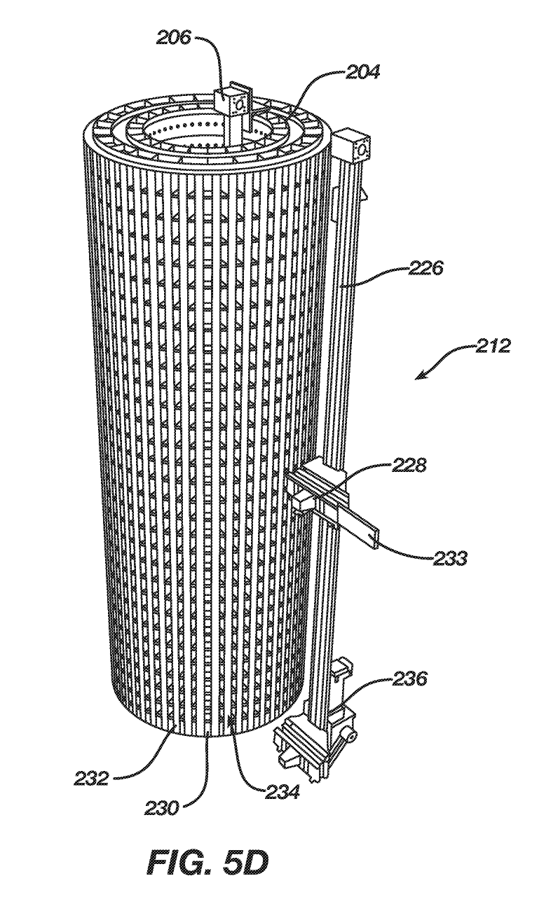

Another embodiment of a dispenser is shown in FIG. 5A, a carousel dispensing system 200. FIG. 5A is a top view of carousel dispensing system 200, showing a top panel 202. The interior volume of the dispensing system 200 comprises a storage area configured to receive products and packages.

FIG. 5B is also a top view of carousel dispensing system 200, with the top panel 202 being removed. As can be seen in FIG. 5B a carousel 204 is substantially circular and is configured to maintain a plurality of packages in openings about its exterior surface, which is shown in later figures. A carousel motor 206 is attached to a base panel 203, with the carousel motor 206 in contact with a portion of the carousel 204 and configured to rotate carousel 204 in a clockwise and counter-clockwise direction as viewed in FIG. 5B.

A front cover 208 shields the carousel 204 from users, and can include one or more displays and/or input devices that can display various images and/or receive various inputs from the users, such as a selection of a package to be dispensed from the carousel dispensing system 200. A side cover 210 extends around the circumference of the carousel dispensing system 200, shielding the carousel 204 from the user around the remaining circumference of carousel dispensing system 200.

A carousel head (product loading unit and transfer unit when combined with the carousel discussed below) 212 is configured to place and remove the plurality of packages within the openings about the exterior surface of the carousel, as further discussed below. The plurality of packages enter and exit the carousel dispensing system 200 through a cover opening 211.

Referring to FIG. 5C, an internal frame 217 includes several components connected to each other, a front frame 216, a side frame 218, a back frame 220 and another side frame 224. The front frame 216 is configured to support each end of a head guide 226, with head guide configured to support a carousel picker head 228. The carousel picker head 228 is configured to move vertically along the head guide 226, which is further discussed below.

Also seen in FIG. 5C is an internal cover 214, which extends around the majority of the circumference and height of the carousel 204, between the carousel 204 and the internal frame 217.

A view of carousel 204 is also seen in FIG. 5D, with the internal cover 214 and the internal frame 217 removed. As can be seen from this view, carousel 204 is comprised of a number of horizontal strips of material 230, operably attached to a number of vertical strips of material 232, which form a plurality of package openings 234, along the height and circumference of the carousel 204, the package openings 234 configured to hold a package 233.

A carousel motor 236 is also attached to the head guide 226, and is configured to move the carousel picker head 228 vertically along the head guide 226 by rotating a belt or the like.

During practice of carousel dispensing system 200, once a suitable package is chosen by a user, carousel motor 206 rotates the appropriate amount so that the suitable package is at a predetermined horizontal position of the carousel 204. The predetermined vertical position is one that corresponds to carousel picker head 228.

Once the suitable package is at the predetermined horizontal position, the carousel motor 236 causes the carousel picker head 228 to move vertically along the head guide 226 to the vertical location of the suitable package. Once at the correct vertical position, a portion of the carousel picker head 228 extends toward the carousel 204, contacts the package within the package opening 234 and moves the package 233 horizontally away from the carousel 204.

Once the package 223 is withdrawn from the carousel 204, the picker head 228 can move to the predetermined vertical position of the cover (delivery) opening 211 and be accessed by a user through the cover opening 211.

Addition of packages to the carousel can occur in a similar, but opposite way to removal of packages, wherein the carousel 204 rotates to the horizontal position of the package opening 234 to be loaded with a package, the picker head 228 moves vertically to the vertical height of the package opening, the package 233 is placed through cover opening 211 by a user and picker head 228 causes the package 233 to move from the cover opening 211 to the selected package opening 234.

Although not shown, each of these dispensers can receive data from a reader, which is operated by a user upon loading of packages into the dispenser. Alternatively or additionally, each of these dispensers can include a reader that automatically scans each package upon addition to the dispenser. The reader can be any suitable reader, such as a bar code reader, a QR code reader, a Radio Frequency Identification (RFID) reader, etc.

The dispenser can then store and/or transmit the amount of and location of each package within the dispenser to the remote/cloud database 300.

Further, although not shown in each dispenser or each view of the dispensers above, each dispenser can include suitable electronic elements, which can include any suitable electronic control boards, processors, computing elements (such as memory, processors, etc.), wiring, etc. along with means to transmit and receive data from a cloud and other third party elements such as tablets and other computers, both in a wireless transmission, as well as a wired transmission.

Although not shown, each of these dispensers can include environmental controls such as temperature and humidity can, which protect the integrity of items within the dispensers. Additional benefits beyond protecting the integrity of product can include product enhancements (such as a “warmed” or “cooled” lens) achieved with a temperature controlling unit (i.e.: heater or air conditioner) so that the lens being stored in the enclosure have a set temperature, enclosure can also be partitioned if multiple conditions are desired. Having environmental controls such as this may also serve to extend product shelf life.

The dispensers discussed above are configured to house and dispense contact lens products at an operator's office. These dispensers would be loaded with the contact lens product at the operator's location and could be locked by the operator so the site personnel could not have access to the product until it was dispensed.

When the operator would require a dispensed product, they would interact with the dispenser via an electronic tablet that would capture information such as, their specific ID number, the subject number, the product Stock Keeping Unit (SKU) and the quantity of the product needed per the clinical protocol. The dispenser would be enabled with software to collect and tabulate this data and communicate it daily to the sponsor and remote/cloud server.

The dispenser could also be capable of measuring the ambient temperature surrounding the contact lens products so any excursion were recorded; this would allow action to be taken on any product that was determined to be stored outside of storage requirements.

If at any time an operator realizes a site may not have enough contact lens products, supplemental product could be sent to the site in a sealed container that could be inserted into the unit. The supplemental (replenished) product would be accounted for by the unit via a reader and automatically added to the inventory.

Some attributes of the above systems are as follows:
The dispensers are a sealed unit that only the operator can access. This means the contact product is in the control of the operator so all returned product can be returned to inventory and possibly re-used in future studies.
Temperature monitoring could be important for temperature sensitive products.
Inventory control software will eliminate the need for monitors and investigator to count product multiple times as done today without the dispenser.
Being able to monitor the inventory remotely will allow the operator to maintain the inventory at an optimal level, preventing the site from running out of product and delaying distribution.
Software could be added to aid the operator with lens selection, thus avoiding major protocol deviations which can add subject risk.
Constant electronic monitoring of the inventory could allow the operator or monitor to detect protocol deviations in real time.
Such a dispenser could be employed for many types of products such as small medical devices (contact lenses) and pharmaceuticals, to name a few.

The described embodiments and examples of the present disclosure are intended to be illustrative rather than restrictive, and are not intended to represent every embodiment or example of the present disclosure. While the fundamental novel features of the disclosure as applied to various specific embodiments thereof have been shown, described and pointed out, it will also be understood that various omissions, substitutions and changes in the form and details of the devices illustrated and in their operation, may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiment of the disclosure may be incorporated in any other disclosed or described or suggested form or embodiment as a general matter of design choice. Further, various modifications and variations can be made without departing from the spirit or scope of the disclosure as set forth in the following claims both literally and in equivalents recognized in law.

1. A dispensing system comprising:
a product loading unit;
a receptacle configured to receive the product loading unit;
a storage area configured to receive product; and
a transfer unit configured to move the product between the product loading unit and the storage area.

2. The dispensing system of claim 1, wherein the product loading unit is a magazine that can be loaded with a plurality of products.

3. The dispensing system of claim 2, wherein the magazine comprises a plurality of shelves, wherein each of the plurality of shelves is configured to hold one of the plurality of products.

4. The dispensing system of claim 2, wherein the transfer unit is configured to move each of the plurality of products from the magazine to a side panel.

5. The dispensing system of claim 4, wherein the system comprises two side panels, and the transfer unit is configured to be between the two side panels.

6. The dispensing system of claim 1, wherein the product is a package of one or more contact lenses.

7. A dispensing system comprising:
a product loading unit;
a receptacle configured to receive the product loading unit;
a storage area configured to receive product;
a transfer unit configured to move the product between the product loading unit and the storage area; and
and a remote system operable to send and/or receive product information from the dispensing system regarding an amount of product and a type of product within the receptacle.

8. The dispensing system of claim 7, wherein the remote system is a cloud database that is configured to receive and/or transmit product information for the dispensing system.

9. The dispensing system of claim 8, wherein the cloud database automatically ships a further product to be loaded into the dispensing system.

10. The dispensing system of claim 8, wherein the cloud database is configured to transmit a dispense instruction for a particular product to the dispensing system.

11. The dispensing system of claim 8, wherein the dispensing system is configured to automatically transmit an inventory of product to the cloud database.

12. The dispensing system of claim 7, wherein the product is a package of one or more contact lenses.

13. The dispensing system of claim 11, wherein the cloud database includes patient information.

14. The dispensing system of claim 13 wherein the patient information includes information of future patient appointments.

15. The dispensing system of claim 14, wherein the dispensing system includes a connection to a supply chain such that the supply chain may anticipate the needed inventory for the dispensing system for a patient based at a future patient appointment.
